(19) United States
(12) Patent Application Publication
(10) Pub. No.: US 2009/0161344 A1
(43) Pub. Date: Jun. 25, 2009

(54) HOLDING MEMBER, ILLUMINATION DEVICE FOR DISPLAY DEVICE HAVING THE HOLDING MEMBER, AND DISPLAY DEVICE HAVING THE HOLDING MEMBER

(75) Inventor: Yoshiki Takata, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/300,652

(22) PCT Filed: Feb. 14, 2007
(86) PCT No.: PCT/JP2007/052615

§ 371 Date: Nov. 13, 2008

(30) Foreign Application Priority Data
Jul. 3, 2006 (JP) 2006-183773

(51) Int. Cl. G02F 1/13357

(52) U.S. Cl. 362/97.1

(57) ABSTRACT

A holding member has holders each holding one end of each of a plurality of parallelly drivable tube lamps and supplying electric power, outputted from a power source device, to the tube lamps. The holding member has buffer sections arranged to buffer thermal stress in the direction in which the tube lamps are arranged. With the holding member, the effect of the buffer section suppresses deformation of the tube lamps occurring in the direction in which the lamps are arranged, so that there is no possibility of lamp breakage due to repeatedly occurring deformation of the tube lamps.

### BACKGROUND OF THE INVENTION

1. Field of the Invention

The present invention relates to a holding member, an illumination device for a display device having the holding member, and a display device having the holding member. More particularly, the present invention relates to a holding member holding the ends of a plurality of lamps that are drivable in parallel, and an illumination device for a display device having the holding member, and a display device having the holding member

2. Description of the Related Art

Because a general cold-cathode tube lamp that is used as a light source in a display device has a non-linear negative impedance characteristic, it cannot be driven in parallel and, usually a power source circuit is used for each cold-cathode tube lamp. In such a structure, because the same number of power source circuits and cold-cathode tube lamps are needed, it has a high cost. Besides, it is disadvantageous in terms of reductions in size, weight, and cost.

In addition, because a general cold-cathode tube lamp used as a light source for a display device is connected to a power source circuit via a harness (also called a lead wire) and a connector, it takes a long time to install a cold-cathode tube lamp, the assembly efficiency of an illumination device for a display device using a cold-cathode tube lamp is poor, and it also takes a long time to remove the cold-cathode tube lamp, so the replacement efficiency of a cold-cathode tube lamp is poor, and the dismount efficiency of an illumination device for a display device using a cold-cathode tube lamp is also low.

As a lamp that can solve these problems, there is an external electrode fluorescent lamp (EEFL) (e.g., see JP-A-2004-31338 and JP-A-2004-39264) and a cold-cathode tube lamp (see International Publication WO2006/051698A1) for which a patent application has been already filed by the applicant of the instant application. These lamps can be driven in parallel, and a holder made of an elastic metal member (e.g., spring steel) holds one end of the lamp with its elastic characteristic so that electric power can be supplied to the lamp. There is an advantage that such a structure allows an easy installation and removal of the lamp.

As shown in FIG. 16, in an illumination device for a display device using lamps that can be driven in parallel as described above, one end of each lamp 200 is held by a holder 201A of a first holding member 201, and the other end of each lamp 200 is held by a holder 202A of a second holding member 202. An AC voltage of dozens of kilohertz is supplied from a power source device 203 to each lamp 200 via the first and second holding members 201, 202. The holders 201A and 202A are made of an elastic metal member (e.g., spring steel), the number of holders 201A disposed is equal to that of lamps, and the number of holders 202A provided is also equal to that of lamps. A sectional view of the second holding member 202 in FIG. 16 taken along the A-A′ line is shown in FIG. 17A, and a sectional view of the second holding member 202 in FIG. 16 taken along the B-B′ line is shown in FIG. 17B. The first holding member 201 has the same shape as the second holding member 202.

As shown in FIG. 18, the first holding member 201 is fixed on a first insulation member 204 with no degree of freedom, and the first insulation member 204 is fixed on a chassis 206 of an illumination device for a display device with no degree of freedom. Likewise, the second holding member 202 is fixed on a second insulation member 205 with no degree of freedom, and the second insulation member 205 is fixed on the chassis 206 of an illumination device for a display device with no degree of freedom.

In a case where the chassis 206 of an illumination device for a display device is made of aluminum or stainless steel, it is necessary to use a structure in which the chassis 206 of an illumination device for a display device does not come into contact with both of the first and second holding members 201 and 202. However, in a case where the chassis 206 of an illumination device for a display device is made of an insulation member such as a resin, the chassis 206 of an illumination device for a display device may come into contact with both of the first and second holding members 201 and 202, the first and second insulation members 204 and 205 may be removed, and the first and second holding members 201 and 202 may be directly fixed on the chassis 206 of an illumination device for a display device.

Because each lamp 200 works as a heat source when it is in service, the first and second holding members 201, 202, the first and second insulation members 204, 205, and the chassis 206 of an illumination device for a display device are exposed to the heat from the lamps and their temperatures rise, thereby they are subjected to thermal expansion.

The first and second holding members 201, 202 are deformed because of difference in temperature (temperature difference) or difference in thermal expansion (thermal-expansion difference) between the first and second holding members 201, 202 made of a metal material and the first and second insulation members 204, 205 made of an insulation material such as a resin. And in the case where the chassis 206 of an illumination device for a display device is made of an insulation member such as a resin, and the first and second insulation members 204, 205 are removed, the first and second holding members 201, 202 are also deformed because of temperature difference or thermal-expansion difference between the first and second holding members 201, 202 and the chassis 206 of an illumination device for a display device. In both cases, if the deformation occurs repeatedly, the first and second holding members 201, 202 will be broken because of metal fatigue in the worst case scenario.

### SUMMARY OF THE INVENTION

To cope with the problems mentioned above, preferred embodiments of the present invention provide a holding member which holds one end of each of a plurality of lamps that are drivable in parallel and are not broken even by repeated deformations, an illumination device for a display device having the holding member, and a display device having the holding member.

A holding member according to a preferred embodiment of the present invention includes a plurality of holders each holding one end of each of tube lamps that are drivable in parallel, supplies electric power output from a power source device to the lamps, and includes a buffer portion to curb deformation stress acting in the direction in which the lamps are arranged.

According to this structure, because deformation occurring in the direction in which the tube lamps are arranged can be curbed, there is no possibility of the breakage of the holding members even if the deformation occurs repeatedly.

It is desirable that at least one buffer portion is disposed between fixed points of each holding member.

Besides, it is desirable that to avoid stress concentration, the buffer portion preferably has a sectional shape that includes at least three bent portions and a connecting portion to connect the bent portions with each other.

An illumination device for a display device according to a preferred embodiment of the present invention includes a plurality of tube lamps that are driven in parallel, a first holding member including holders each of which holds one end of each of the tube lamps and the number of which is the same as that of the tube lamps, a second holding member including holders each of which holds the other end of each of the tube lamps and the number of which is the same as that of the tube lamps, a power source device arranged to supply electric power to the tube lamps via the first holding member and the second holding member, and a chassis of an illumination device for a display device, wherein the first and second holding members are holding members each having any one of the structures describe above. If it is possible to supply electric power to the tube lamps via the first and second holding members by capacitive coupling and the like, an insulation coating may be applied to the holders.

In a case where the chassis of an illumination device for a display device is made of an electroconductive material, it is desirable that an insulator is disposed between the chassis of an illumination device for a display device and the first holding member and between the chassis of an illumination device for a display device and the second holding member so that the chassis of an illumination device for a display device does not come into contact with both of the first and second holding members.

In the illumination device for a display device having each of the structures described above, the first and second holding members may be fixed on the chassis of an illumination device for a display device in a state that they have degree of freedom in a direction (main-axis direction) of the main axis of the tube lamp. According to this structure, because the first and second holding members are fixed on the chassis of an illumination device for a display device in a state that they have degree of freedom in the main-axis direction of the tube lamp, the first and second holding members can move together with the tube lamps responding to thermal expansion or thermal shrinkage of the tube lamps. Accordingly, thermal stress in the main-axis direction acting on the tube lamps can be dramatically reduced, and the tube lamps can be prevented from being damaged by the thermal stress. Further, the first and second holding members may be structured such that they each have a plurality of fixed points which, with respect to the chassis of an illumination device for a display device, have a degree of freedom in the main-axis direction of the tube lamp and have no degree of freedom in the direction in which the lamps are arranged, and with respect to the chassis of an illumination device for a display device, they have no fixed points which have a degree of freedom in both of the main-axis direction of the tube lamp and the direction in which the lamps are arranged. According to this structure, it is possible to prevent the first and second holding members from being deformed in the direction in which the tube lamps are arranged, and is also possible to prevent the first and second holding members from becoming loose in the direction in which the tube lamps are arranged.

In the illumination device for a display device having each of the structures described above, a plurality of sets of the first holding member, the second holding member, and the tube lamps which are held by the holder of the first holding member and the holder of the second holding member may be disposed. This structure allows an easy application of the illumination device to a large display screen.

Further, a display device (e.g., a television receiver) according to a preferred embodiment of the present invention includes an illumination device for a display device having the structure described above.

According to various preferred embodiments the present invention, because the holding members can be prevented from being deformed in the direction in which the tube lamps are arranged with the aid of operation of the buffer portions, there is no possibility of the breakage of the holding members due to repeated deformations.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic sectional view of a cold-cathode tube lamp that is drivable in parallel.

FIG. 2 is a view showing a schematic structure of an illumination device for a display device according to a first preferred embodiment of the present invention.

FIG. 3 is a view showing a structure of the illumination device for a display device according to the first preferred embodiment of the present invention including a chassis of the illumination device for a display device.

FIG. 4 is a partially enlarged view of a fixed point of a first holding member of the illumination device for a display device according to the first preferred embodiment of the present invention.

FIG. 5A is a view showing a shape of a second holding member of the illumination device for a display device illustrated in FIG. 2.

FIG. 5B is a view showing a shape of the second holding member of the illumination device for a display device illustrated in FIG. 2.

FIG. 5C is a view showing a shape of the second holding member of the illumination device for a display device illustrated in FIG. 2.

FIG. 6A is a view showing a modification of the second holding member of the illumination device for a display device illustrated in FIG. 2.

FIG. 6B is a view showing a modification of the second holding member of the illumination device for a display device illustrated in FIG. 2.

FIG. 6C is a view showing a modification of the second holding member of the illumination device for a display device illustrated in FIG. 2.

FIG. 7A is a view showing another modification of the second holding member of the illumination device for a display device illustrated in FIG. 2.

FIG. 7B is a view showing another modification of the second holding member of the illumination device for a display device illustrated in FIG. 2.

FIG. 8A is a view showing a schematic structure of an illumination device for a display device according to a second preferred embodiment of the present invention.

FIG. 8B is a view showing a modification of the illumination device for a display device according to the second preferred embodiment of the present invention.

FIG. 9A is a partially enlarged view of a fixed point formed through the center of a first holding member of the illumination device for a display device according to the second preferred embodiment of the present invention.

FIG. 9B is a partially enlarged view of the fixed point formed in the center of the first holding member of the illumination device for a display device according to the second preferred embodiment of the present invention.

FIG. 10 is a view showing a schematic structure of an illumination device for a display device according to a third preferred embodiment of the present invention.

FIG. 11 is a view showing a modification of the illumination device for a display device according to the third preferred embodiment of the present invention.

FIG. 12 is a view showing a schematic structure of an illumination device for a display device according to a fourth preferred embodiment of the present invention.

FIG. 13 is a view showing a modification of the illumination device for a display device according to the fourth preferred embodiment of the present invention.

FIG. 14A is a partially enlarged view of a fixed point formed through the center of the first holding member of the illumination device for a display device according to the second preferred embodiment of the present invention in a case where an engagement portion is employed.

FIG. 14B is a partially enlarged view of the fixed point formed in the center of the first holding member of the illumination device for a display device according to the second preferred embodiment of the present invention in a case where an engagement portion is employed.

FIG. 15 is an exploded perspective view of a liquid crystal television receiver as an example of a display device according to the present invention.

FIG. 16 is a view showing a schematic structure of a conventional illumination device for a display device.

FIG. 17A is a view showing a sectional shape of a second holding member of the illumination device for a display device illustrated in FIG. 16.

FIG. 17B is a view showing a sectional shape of the second holding member of the illumination device for a display device illustrated in FIG. 16.

FIG. 18 is a view showing a structure of a conventional illumination device for a display device including a chassis of the illumination device for a display device.

### DETAILED DESCRIPTION OF THE PREFERRED EMBODIMENTS

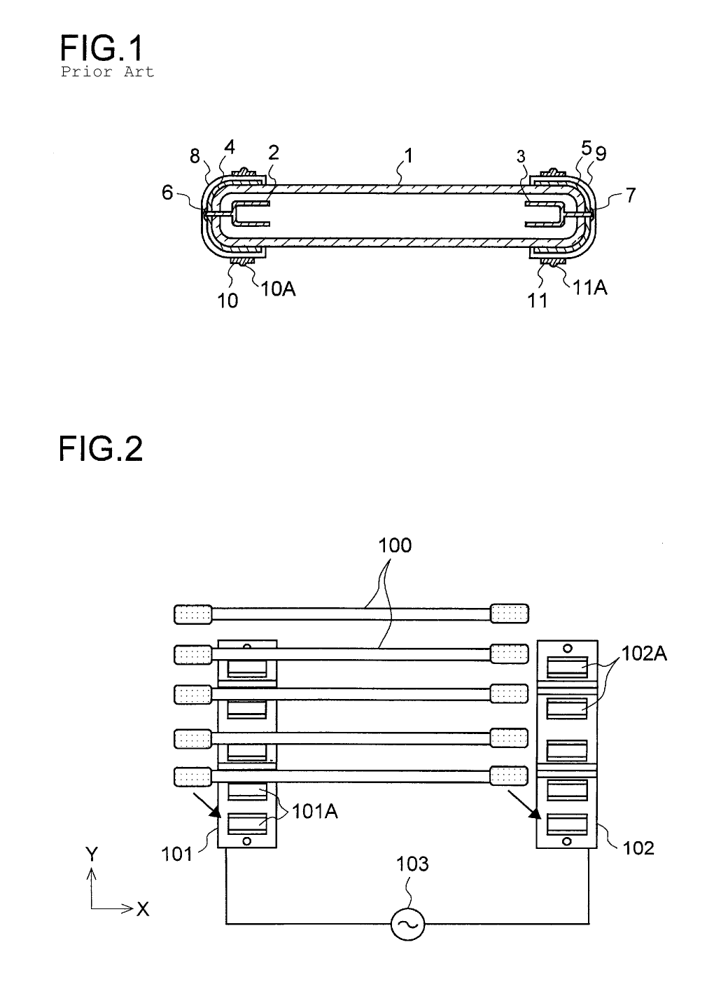

Preferred embodiments of the present invention are explained below with reference to the drawings. In the preferred embodiments explained below, a cold-cathode tube lamp having a sectional structure shown in FIG. 1 is used as a light source for a display device.

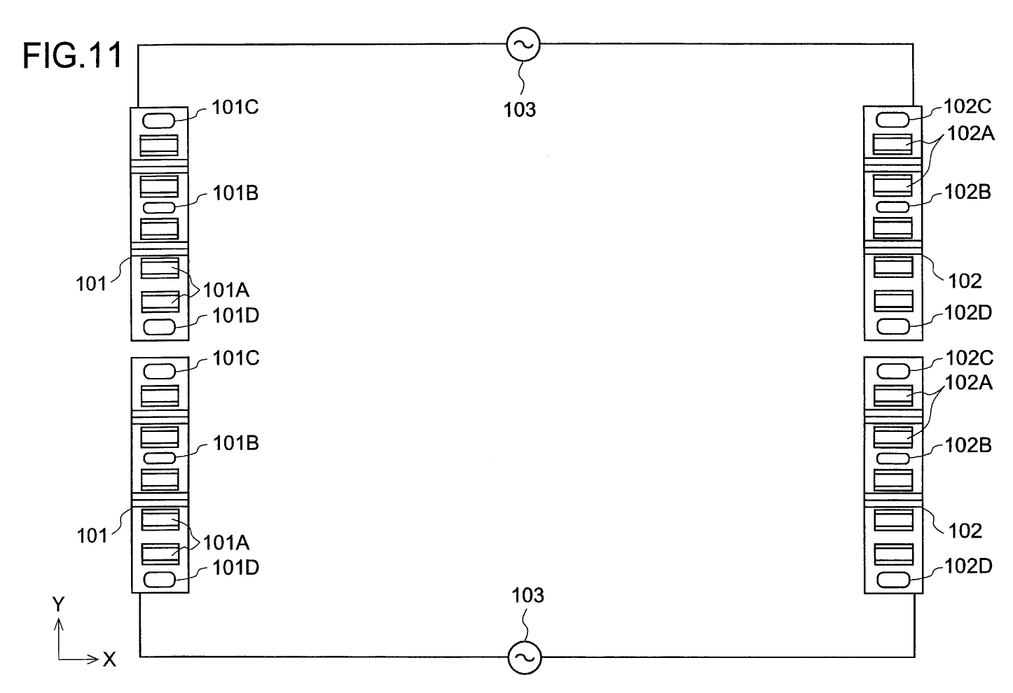

The cold-cathode tube lamp shown in FIG. 1 is one of the cold-cathode tube lamps disclosed in International Publication WO2006/051698A1 (see FIG. 11B).

The cold-cathode tube lamp shown in FIG. 1 has a glass tube 1, and internal electrodes 2, 3 disposed in the glass tube 1. A portion of each of the internal electrodes 2, 3 penetrates the glass tube 1, protrudes outside, and functions as an electrode terminal. In the foregoing structure, the glass tube 1 is tightly closed. The inner wall of the glass tube 1 is coated with a fluorescent material. Generally, neon and argon having a ratio of about 95(neon):5 (argon) or a ratio of about 80:20 are sealed in the tightly closed glass tube 1, and further a few milligrams of mercury is sealed so that the pressure in the glass tube 1 becomes approximately 10.7×10³ to 5.3×10³ Pa (≈80 to 40 Torr). Xenon is sometimes sealed instead of mercury.

In the cold-cathode tube lamp shown in FIG. 1, external electrodes 4, 5 are disposed on both end portions of the glass tube 1, the protruding portion of the internal electrode 2 is soldered to the external electrode 4 with solder 6, and the protruding portion of the inner electrode 3 is soldered to the external electrode 5 with solder 7. Specifically, the external electrodes 4, 5 are formed of metal paste, metal foil, a metal cap, etc. If the electrical connection between the protruding portion of the internal electrode 2 and the external electrode 4, and the electrical connection between the protruding portion of the internal electrode 3 and the external electrode 5 are secured sufficiently, the solder 6, 7 may not be used.

In the cold-cathode tube lamp shown in FIG. 1, insulation layers 8, 9 are formed on the external electrodes, and circular belt electrodes (opposite electrodes) 10, 11 are formed on the insulation layers 8, 9, respectively. The entire external electrode 4 is covered by the glass tube 1 and the insulation layer 8, and the entire external electrode 5 is covered by the glass tube 1 and the insulation layer 9.

Further, in the cold-cathode tube lamp shown in FIG. 1, to ensure the electrical connection between the opposite electrode 10 and the holder, and the electrical connection between the opposite electrode 11 and the holder, circular convex portions 10A, 11A are disposed on the circular belt opposite electrodes 10, 11, respectively.

Next, a first preferred embodiment of the present invention is explained. A schematic structure of an illumination device for a display device according to the first preferred embodiment of the present invention is shown in FIG. 2. In the illumination device for a display device according to the first preferred embodiment of the present invention, one end of each lamp 100, that is, the cold-cathode tube lamp having the structure shown in FIG. 1, is held by a holder 101A of a first holding member 101, and the other end of each lamp 100 is held by a holder 102A of a second holding member 102. An AC voltage of dozens of kilohertz is supplied from a power source device 103 to each lamp 100 via the first and second holding members 101, 102. The holders 101A, 102A are formed of an elastic metal member (e.g., spring steel), the number of holders 101A is the same as that of the lamps, and the number of holders 102A is also the same as that of the lamps. Each of the first and second holding members 101, 102 is provided with through-holes in the upper and lower end portions in the direction (the Y-axis direction in FIG. 2) in which the lamps are arranged.

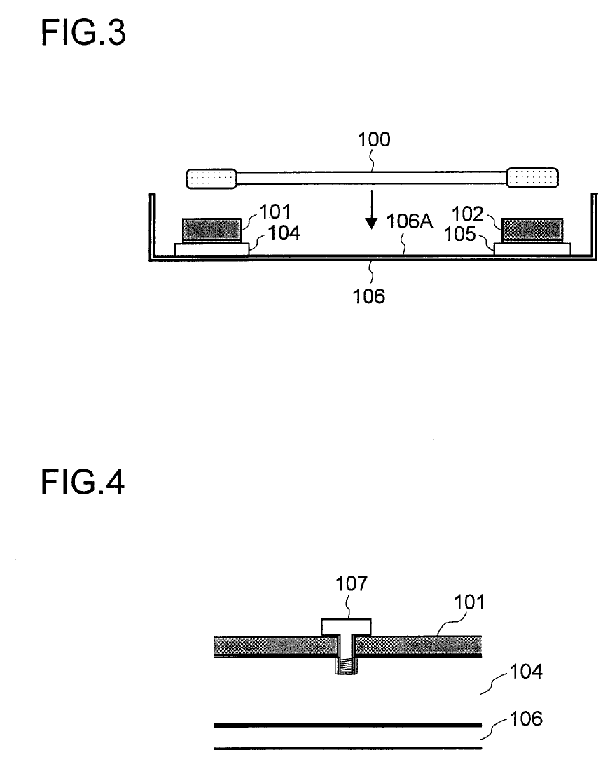

Here, a structure of the illumination device for a display device according to the first preferred embodiment of the present invention including a chassis of the illumination device for a display device is shown in FIG. 3. The first holding member 101 is fixed on a first insulation member 104 with no degree of freedom by a screw (not shown in FIG. 3) inserted through the through-hole formed through the upper portion in the direction (the Y-axis direction in FIG. 2) in which the lamps are arranged, and by a screw (not shown in FIG. 3) inserted through the through-hole formed through the lower portion in the direction (the Y-axis direction in FIG. 2) in which the lamps are arranged. The first insulation member 104 is fixed on a chassis 106 of the illumination device for a display device. A partially enlarged view of a fixed point of the first holding member 101 is shown in FIG. 4. FIG. 4 is a sectional view in the Y-axis direction in FIG. 2. A screw 107 is threaded into the first insulation member 104 via the through-hole of the first holding member 101.

Likewise, the second holding member 102 is fixed on a second insulation member 105 with no degree of freedom by a screw (not shown in FIG. 3) inserted through the through-hole formed through the upper portion in the direction (the Y-axis direction in FIG. 2) in which the lamps are arranged, and by a screw (not shown in FIG. 3) inserted through the through-hole formed through the lower portion in the direction (the Y-axis direction in FIG. 2) in which the lamps are arranged. The second insulation member 105 is fixed on the chassis 106 of the illumination device for a display device.

The first and second holding members 101, 102 as the holding members according to a preferred embodiment of the present invention are provided with buffer portions which buffer thermal stress acting in the direction in which the lamps are arranged. In the holding member according to a preferred embodiment of the present invention, the buffer portion to the number of at least one (e.g., two buffer portions in the first preferred embodiment) are formed between fixed points of each of the first and second holding members 101, 102 (e.g., in the first preferred embodiment of the present invention, as for the first holding member 101, between the two through-holes one of which is formed through the upper portion, and the other one of which is formed through the lower portion; as for the second holding member 102, between the two through-holes one of which is formed through the upper portion, and the other one of which is formed through the lower portion).

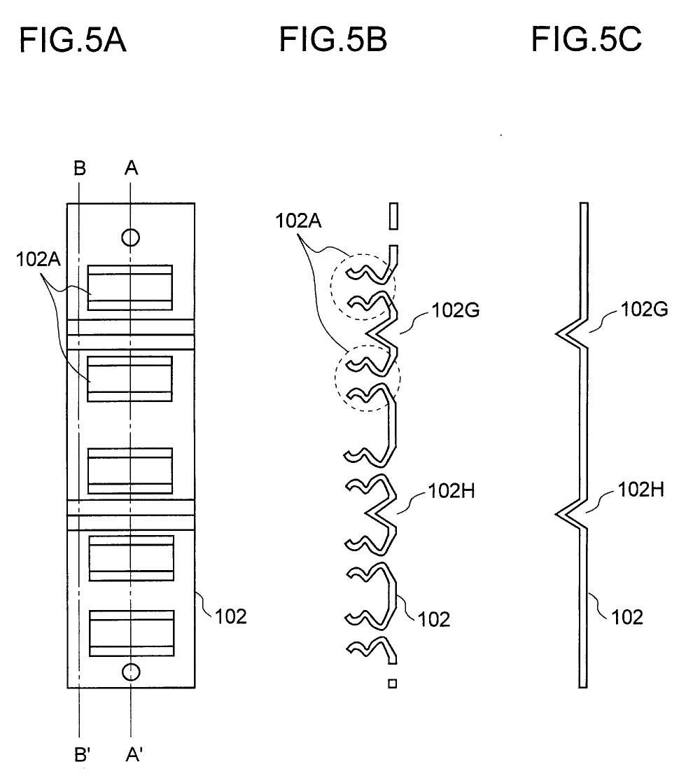

Here, a shape of the second holding member 102 of the illumination device for a display device according to the first preferred embodiment of the present invention is shown in FIGS. 5A and 5B. FIG. 5B is a sectional view taken along the A-A′ line in FIG. 5A, and FIG. 5C is a sectional view taken along the B-B′ line in FIG. 5A. The second holding member 102 has buffer portions 102G, 102H between the through-hole formed through the upper portion and the through-hole formed through the lower portion.

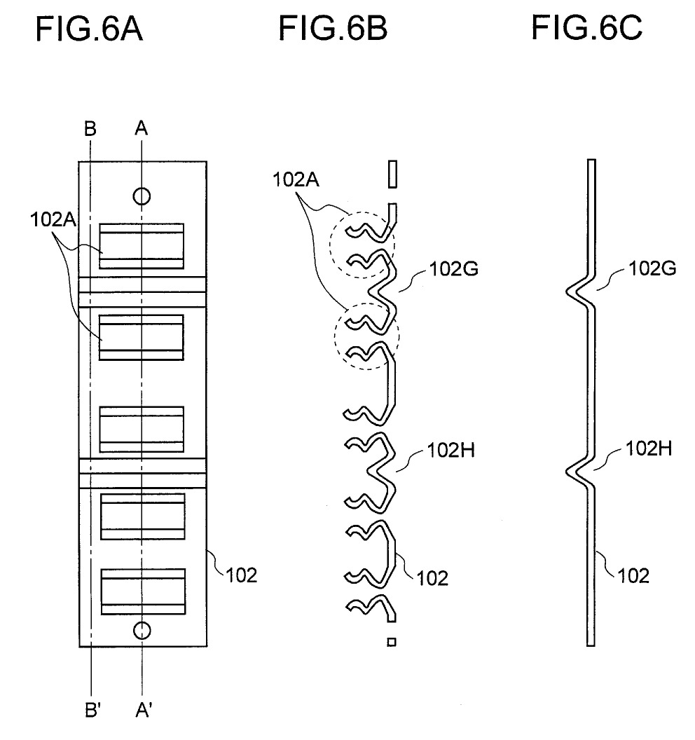

It is desirable to form the shapes shown in FIGS. 6A and 6B using the refracted portions of the buffer portions 102G, 102H shown in FIG. 5 as the bent portions. As shown in FIGS. 6A and 6B, because the buffer portion has a sectional shape that includes at least three bent portions and a connecting portion to connect the bent portions with each other, it is possible to avoid stress concentration occurring at the refracted portions shown in FIGS. 5A, 5B.

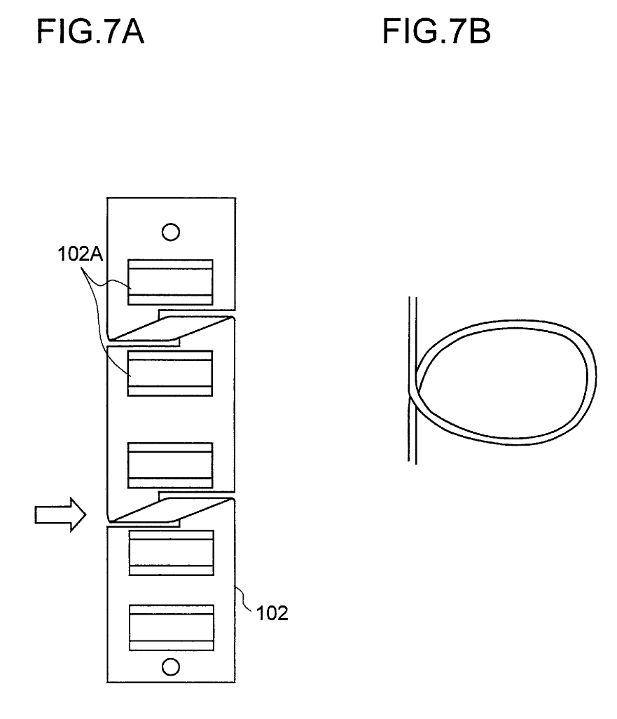

As another shape of the buffer portion, there is a loop shape shown in FIGS. 7A, 7B. FIG. 7B is a partially enlarged view of the buffer portion seen from the arrow direction in FIG. 7A.

Because the first and second holding members 101, 102 are provided with the buffer portions explained above, it is possible to prevent the first and second holding members 101, 102 from being deformed in the direction in which the lamps are arranged by temperature difference or thermal-expansion difference between the first and second holding members 101, 102 and the first and second insulation members 104, 105; and it is also possible to prevent the first and second holding members 101, 102 from being deformed in the direction in which the lamps are arranged by temperature difference or thermal-expansion difference between the first and second holding members 101, 102 and the chassis 106 of the illumination device for a display device in the case where the chassis 106 of the illumination device for a display device is formed of an insulation material such as a resin, and the first and second insulation members 104, 105 are removed. Thus, it is possible to prevent the breakage of the first and second holding members due to repeated deformations.

Because a light reflection sheet made of an insulation resin is usually disposed on the inner-side rear surface 106A of the chassis of the illumination device for a display device, the first and second insulation members 104, 105 can be removed, and the light reflection sheet can be used to serve as the first and second insulation members 104, 105 concurrently. Besides, another structure may be employed, in which an insulation coating is applied to the inner-side rear surface 106A (see FIG. 3) of the chassis of the illumination device for a display device, the first and second insulation members 104,105 are removed, and the insulation coating is used instead of the first and second insulation members 104, 105.

If the chassis 106 of the illumination device for a display device is made of aluminum or stainless steel, it is necessary to prevent the chassis 106 of the illumination device for a display device from coming into contact with both the first and second holding members 101, 102. However, if the chassis 106 of the illumination device for a display device is made of an insulation material such as a resin, because it is not a problem even if the chassis 106 of the illumination device for a display device comes into contact with both the first and second holding members 101, 102, the first and second insulating members 104, 105 can be removed, and the first and second holding members 101, 102 may be fixed on the chassis 106 of the illumination device for a display device with a screw.

Next, a second preferred embodiment of the present invention is explained. Here, a state of the illumination device for a display device at the time of startup is explained. Before startup, the lamps and the chassis of the illumination device for a display device have a room temperature (e.g., about 25° C.), but after the lamps are turned on by startup, the temperatures of the lamps increase to about 80° C. immediately (e.g., in a few minutes). In contrast, the temperature of the chassis of the illumination device for a display device gradually (e.g., in an hour or longer) increases to about 50° C. from the room temperature.

Next, a state of the illumination device for a display device at the end of operation is explained. On the lamps being turned off at the end of operation, the temperatures of the lamps rapidly (e.g., in a few minutes) fall from about 80° C. to about 50° C., then, decrease gradually (e.g., in an hour or longer) to the room temperature. In contrast, the temperature of the chassis of the illumination device for a display device gradually (e.g., in an hour or longer) decreases to the room temperature.

This phenomenon occurs because while each lamp is a heat source, has a small heat capacity, and its temperature changes rapidly, the chassis of the illumination device for a display device is not a heat source, is exposed to the heat from the lamps, has a large heat capacity, and its temperature changes slowly compared with the lamps.

In the above-explained illumination device for a display device according to the first preferred embodiment of the present invention, because the first and second holding members 101, 102 are fixed on the chassis 106 of the illumination device for a display device with no degree of freedom via the first and second insulation members 104, 105, a large thermal stress acts on the lamps if the phenomenon explained above occurs, and the lamps could be broken. In addition, because the lamps are driven in parallel, an especially large thermal stress acts on the lamps.

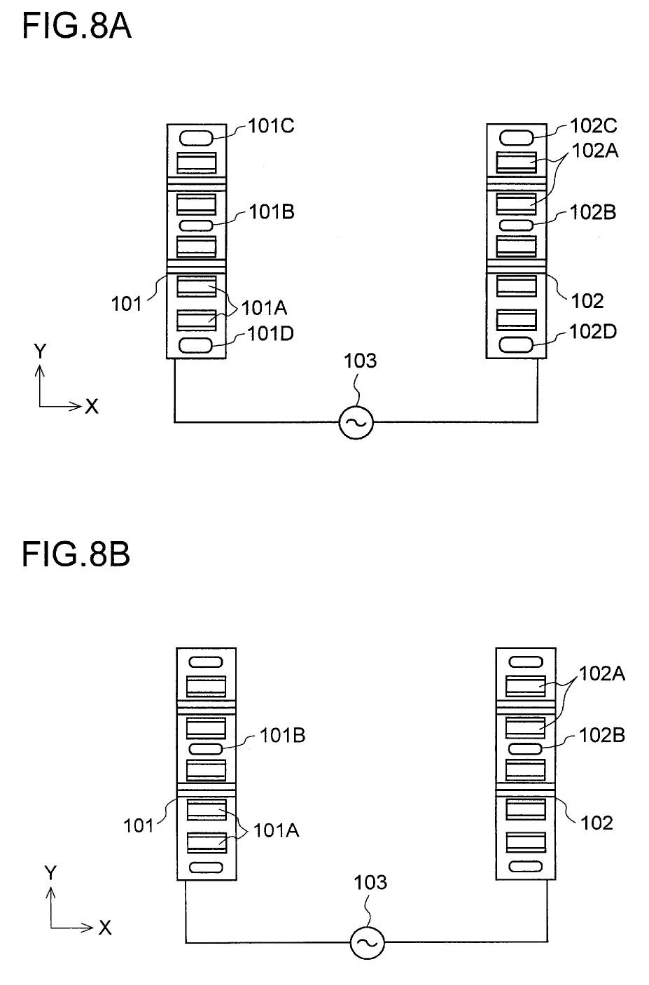

An illumination device for a display device according to the second preferred embodiment of the present invention is structured to suppress the possibility of the lamps being broken by thermal stress. A schematic structure of the illumination device for a display device according to the second preferred embodiment of the present invention is shown in FIG. 8A. In FIG. 8A, the same reference numbers are used to indicate the same elements as those in FIG. 2, and their explanations are skipped. The lamps illustrated in FIG. 2 are not shown in FIG. 8A.

Like the illumination device for a display device according to the first preferred embodiment of the present invention, the illumination device for a display device according to the second preferred embodiment of the present invention preferably includes the first insulation member 104, the second insulation member 105, and the chassis 106 of the illumination device for a display device (see FIG. 3).

The illumination device for a display device according to the second preferred embodiment of the present invention is different from the illumination device for a display device according to the first preferred embodiment of the present invention in that the first holding member 101 includes oblong holes 101B, 101C and 101D instead of the circular through-holes; the second holding member 102 includes oblong holes 102B, 102C and 102D instead of the circular through-holes; a screw suitable for the oblong hole is used instead of the screw 7 (see FIG. 4), and to match these structures, the first insulation member 104, the second insulation member 105, and the chassis 106 of the illumination device for a display device have different shapes.

As for the first holding member 101, the oblong hole 101B, which is long in the main-axis direction of the lamp (the X-axis direction in FIG. 8A), is formed through substantially the central portion in the direction (the Y-axis direction in FIG. 8A) in which of the lamps are arranged. The oblong hole 101C is formed through the upper end portion in the direction (the Y-axis direction in FIG. 8A) in which the lamps are arranged, the oblong hole 101C extends long in the main-axis direction (the X-axis direction in FIG. 8A) of the lamp and has a width larger than that of the oblong hole 101B in the direction (the Y-axis direction in FIG. 8A) in which the lamps are arranged. And the oblong hole 101D is formed through the lower end portion in the direction (the Y-axis direction in FIG. 8A) in which the lamps are arranged, the oblong hole 101D extends long in the main-axis direction (the X-axis direction in FIG. 8A) of the lamp and has a width larger than that of the oblong hole 101B in the direction (the Y-axis direction in FIG. 8A) in which the lamps are arranged.

Likewise, as for the second holding member 102, the oblong hole 102B is formed through substantially the central portion in the direction (the Y-axis direction in FIG. 8A) in which of the lamps are arranged. The oblong hole 102B extends long in the main-axis direction (the X-axis direction in FIG. 8A) of the lamp. The oblong hole 102C is formed through the upper end portion in the direction (the Y-axis direction in FIG. 8A) in which the lamps are arranged, and the oblong hole 102C has a width larger than that of the oblong hole 102B in the direction (the Y-axis direction in FIG. 8A) in which the lamps are arranged. The oblong hole 102C extends long in the main-axis direction (the X-axis direction in FIG. 8A) of the lamp. And the oblong hole 102D is formed through the lower end portion in the direction (the Y-axis direction in FIG. 8A) in which the lamps are arranged, and the oblong hole 102D has a width larger than that of the oblong hole 102B in the direction (the Y-axis direction in FIG. 8A) in which the lamps are arranged. The oblong hole 102D extends longitudinally in the main-axis direction (the X-axis direction in FIG. 8A) of the lamp. The oblong holes 101B, 102B are preferably symmetrically arranged, that is, the line (not shown) linking the oblong hole 101B with the oblong hole 102B is substantially parallel with the X-axis direction shown in FIG. 8A.

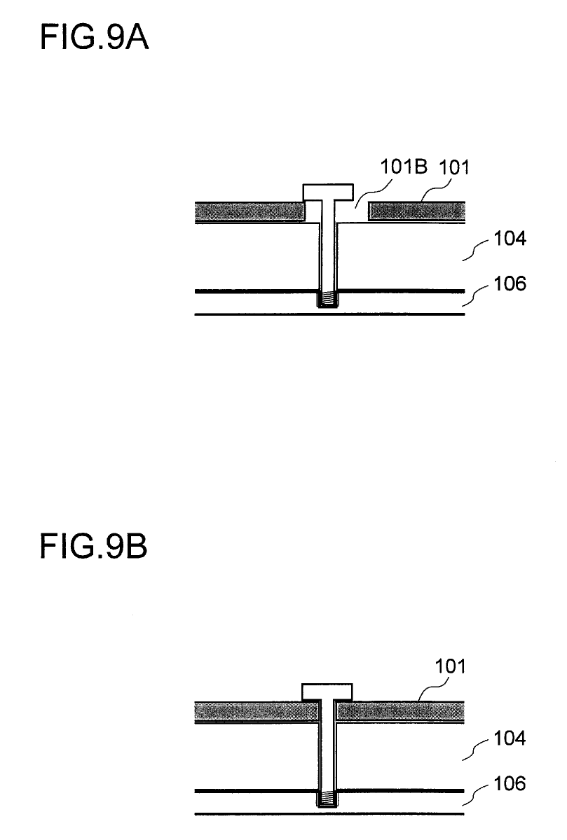

The first holding member 101 is not fixed on the first insulation member 104, and the first insulation member 104 is fixed on the chassis 106 of the illumination device for a display device with no degree of freedom. At the oblong hole 101B, the first holding member 101 is loosely mounted preferably by a screw (insulation-material screw), for example, made of an insulation material on the chassis 106 of the illumination device for a display device with degree of freedom in the main-axis direction (the X-axis direction in FIG. 8A) of the lamp and with no degree of freedom in the direction (the Y-axis direction in FIG. 8A) in which the lamps are arranged. Because the second holding member 102 is mounted like the first holding member 101, the detailed description is skipped. A partially enlarged view of the oblong hole 101B of the first holding member 101 and a portion near the oblong hole 101B is shown in FIGS. 9A, 9B. FIG. 9A is a sectional view in the X-axis direction in FIG. 8A, with the holder 101A not shown. FIG. 9B is a sectional view in the Y-axis direction in FIG. 8A. The screw is threaded into the chassis 106 of the illumination device for a display device via the oblong hole 101B of the first holding member 101 and the through-hole of the first insulation member 104.

When each lamp 100 is thermally expanding or shrinking, the first and second holding members 101, 102 try to move together with each lamp. In the illumination device for a display device according to the second preferred embodiment of the present invention, because the first and second holding members 101, 102 are loosely mounted on the chassis 106 of the illumination device for a display device so that they have a degree of freedom in the main-axis direction (the X-axis direction in FIG. 8A) of the lamp, the first and second holding members 101, 102 can move together with each lamp following the thermal expansion or thermal shrinkage. Accordingly, it is possible to dramatically reduce thermal stress acting on each lamp in the main-axis direction, and is also possible to lower the possibility of each lamp being broken by thermal stress.

Further, because the central portions of the first and second holding members 101, 102 are the fixed points with respect to the direction (the Y-axis direction in FIG. 8A) in which the lamps are arranged, and because the upper and lower ends are free ends (provided that displacement amount is limited), it is possible to prevent the first and second holding members 101, 102 from being deformed in the direction in which the lamps are arranged with the aid of operation of the oblong holes besides operation of the buffer portions.

Besides, because a light reflection sheet made of an insulation material is usually disposed on the inner-side rear surface 106A (see FIG. 3) of the chassis of the illumination device for a display device, the first and second insulation members 104, 105 can be removed, and the light reflection sheet may be used to serve as the first and second insulation members 104, 105 concurrently. In addition, another structure may be employed, in which an insulation coating is applied to the inner-side rear surface 106A (see FIG. 3) of the chassis of the illumination device for a display device, the first and second insulation members 104,105 are removed, and the insulation coating is used instead of the first and second insulation members 104, 105.

If the chassis 106 of the illumination device for a display device is made of aluminum or stainless steel, it is necessary to prevent the chassis 106 of the illumination device for a display device from coming into contact with both the first and second holding members 101, 102. However, if the chassis 106 of the illumination device for a display device is made of an insulation material such as a resin, because it is not a problem even if the chassis 106 of the illumination device for a display device comes into contact with both the first and second holding members 101 and 102, the first and second insulating members 104, 105 can be removed. And, at the oblong hole 101B, the first holding member 101 is mounted on the chassis 106 of the illumination device for a display device by an insulation-material screw with degree of freedom in the main-axis direction (the X-axis direction in FIG. 8A) of the lamp and with no degree of freedom in the direction (the Y-axis direction in FIG. 8A) in which the lamps are arranged. Further, at the oblong holes 101C and 101D, the first holding member 101 is mounted on the chassis 106 of the illumination device for a display device by an insulation-material screw with degree of freedom in both the main-axis direction (the X-axis direction in FIG. 8A) of the lamp and the direction (the Y-axis direction in FIG. 8A) in which the lamps are arranged. Moreover, at the oblong hole 102B, the second holding member 102 is mounted on the chassis 106 of the illumination device for a display device by an insulation-material screw with degree of freedom in the main-axis direction (the X-axis direction in FIG. 8A) of the lamp and with no degree of freedom in the direction (the Y-axis direction in FIG. 8A) in which the lamps are arranged. Further, at the oblong holes 102C and 102D, the second holding member 102 is mounted on the chassis 106 of the illumination device for a display device by an insulation-material screw with degree of freedom in both the main-axis direction (the X-axis direction in FIG. 8A) of the lamp and the direction (the Y-axis direction in FIG. 8A) in which the lamps are arranged.

Because the buffer portions of the first and second holding members 101, 102 can prevent the first and second holding members 101, 102 from being deformed in the direction in which the lamps are arranged, all the oblong holes of the first and second holding members 101, 102 may be formed into the same shape as those of the oblong holes 101B and 102B as shown in FIG. 8B. According to this structure, it is possible to prevent the first and second holding members 101, 102 from becoming loose in the direction in which the lamps are arranged.

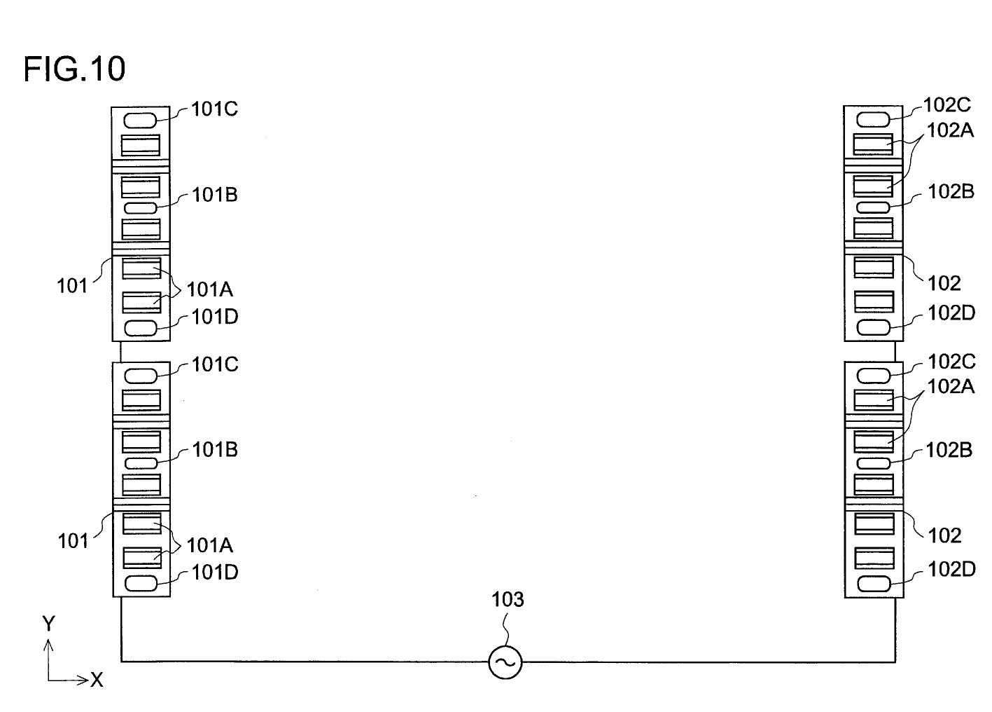

Next, a third preferred embodiment of the present invention is explained. A schematic structure of an illumination device for a display device according to the third preferred embodiment of the present invention is shown in FIG. 10. In FIG. 10, the same reference numbers are used to indicate the same elements as those in FIG. 8A, and their explanations are skipped. The lamps are not shown as in FIG. 8A.

Like the illumination device for a display device according to the first and second preferred embodiments of the present invention, the illumination device for a display device according to the third preferred embodiment of the present invention includes the first insulation member 104, the second insulation member 105, and the chassis 106 of the illumination device for a display device (see FIG. 3).

The illumination device for a display device according to the third preferred embodiment of the present invention includes two sets of the lamps, the first holding member 101, the second holding member 102, the first insulation member 104, and the second insulation member 105 which the illumination device for a display device according to the second preferred embodiment of the present invention comprises, and a parallel electric circuit is formed as an electric circuit. The structure having the two sets of the first and second holding members 101, 102 allows an easy application of the illumination device to a large display screen. As in a modification shown in FIG. 11, two power source devices 103 may be disposed to form two parallel electric circuits.

Besides, because a light reflection sheet made of an insulation material is usually disposed on the inner-side rear surface 106A (see FIG. 3) of the chassis of the illumination device for a display device, the first and second insulation members 104, 105 can be removed, and the light reflection sheet may be used to serve as the first and second insulation members 104, 105 concurrently. In addition, another structure may be employed, in which an insulation coating is applied to the inner-side rear surface 106A (see FIG. 3) of the chassis of the illumination device for a display device, the first and second insulation members 104,105 are removed, and the insulation coating is used instead of the first and second insulation members 104, 105.

If the chassis 106 of the illumination device for a display device is made of aluminum or stainless steel, it is necessary to prevent the chassis 106 of the illumination device for a display device from coming into contact with both the first and second holding members 101, 102. However, if the chassis 106 of the illumination device for a display device is made of an insulation material such as a resin, because it is not a problem even if the chassis 106 of the illumination device for a display device comes into contact with both the first and second holding members 101 and 102, the first and second insulating members 104, 105 can be removed. And, at the oblong hole 101B, the first holding member 101 is mounted on the chassis 106 of the illumination device for a display device by an insulation-material screw with degree of freedom in the main-axis direction (the X-axis direction in FIG. 10) of the lamp and with no degree of freedom in the direction (the Y-axis direction in FIG. 10) in which the lamps are arranged. Further, at the oblong holes 101C and 101D, the first holding member 101 is mounted on the chassis 106 of the illumination device for a display device by insulation-material screws with degree of freedom in both the main-axis direction (the X-axis direction in FIG. 10) of the lamp and the direction (the Y-axis direction in FIG. 10) in which the lamps are arranged. Moreover, at the oblong hole 102B, the second holding member 102 is mounted on the chassis 106 of the illumination device for a display device by an insulation-material screw with degree of freedom in the main-axis direction (the X-axis direction in FIG. 10) of the lamp and with no degree of freedom in the direction (the Y-axis direction in FIG. 10) in which the lamps are arranged. Further, at the oblong holes 102C and 102D, the second holding member 102 is mounted on the chassis 106 of the illumination device for a display device preferably by insulation-material screws with degree of freedom in both the main-axis direction (the X-axis direction in FIG. 10) of the lamp and the direction (the Y-axis direction in FIG. 10) in which the lamps are arranged.

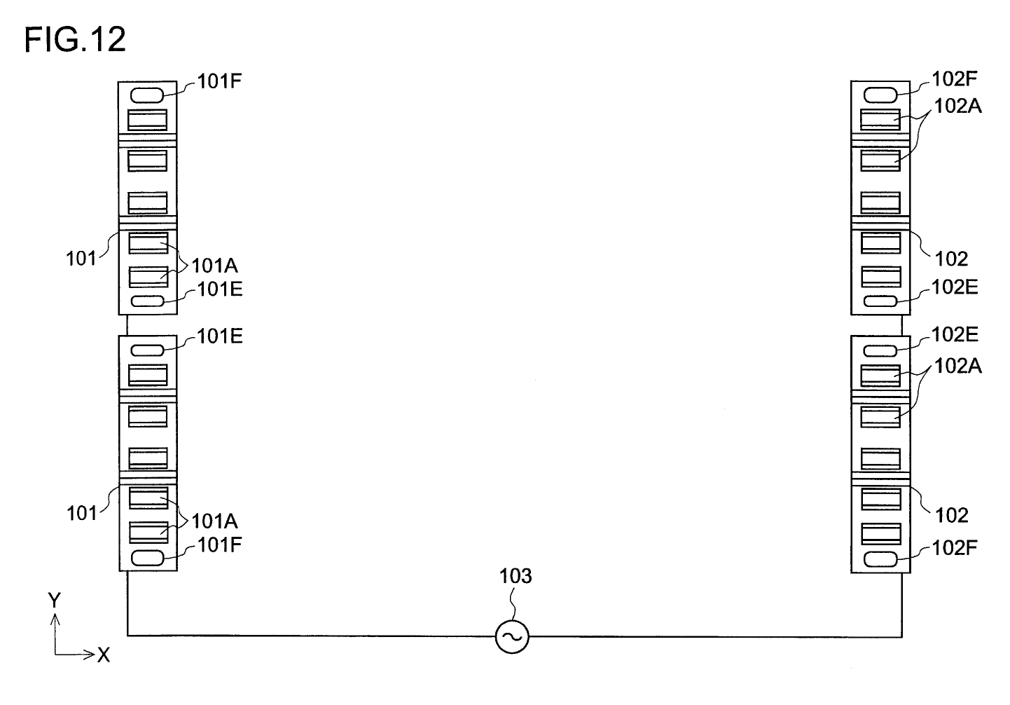

Next, a fourth preferred embodiment of the present invention is explained. A schematic structure of an illumination device for a display device according to the fourth preferred embodiment of the present invention is shown in FIG. 12. In FIG. 12, the same reference numbers are used to indicate the same elements as those in FIG. 10, and their explanations are skipped. The lamps are not shown as in FIG. 10.

Like the illumination device for a display device according to the first, second and third preferred embodiments of the present invention, the illumination device for a display device according to the fourth preferred embodiment of the present invention includes the first insulation member 104, the second insulation member 105, and the chassis 106 of the illumination device for a display device (see FIG. 3).

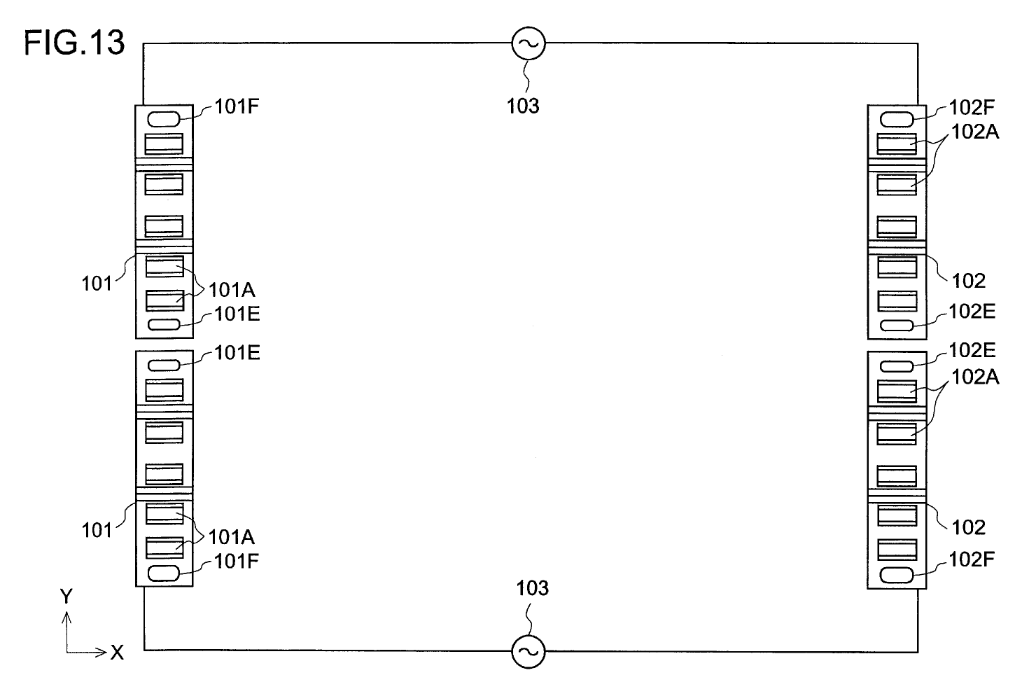

The illumination device for a display device according to the fourth preferred embodiment of the present invention is different from the illumination device for a display device according to the third preferred embodiment of the present invention in that the first holding member 101 includes: instead of the oblong hole 101B, an oblong hole 101E having the same shape as that of the oblong hole 101B through one end portion of the first holding member 101 in the direction (the Y-axis direction in FIG. 12) in which the lamps are arranged; and instead of the oblong holes 101C and 101D, an oblong hole 101F having the same shape as those of the oblong holes 101C, 101D through the other end portion of the first holding member 101 in the direction (the Y-axis direction in FIG. 12) in which the lamps are arranged; the second holding member 102 includes: instead of the oblong hole 102B, an oblong hole 102E having the same shape as that of the oblong hole 102B through one end portion of the second holding member 102 in the direction (the Y-axis direction in FIG. 12) in which the lamps are arranged; and instead of the oblong holes 102C and 102D, an oblong hole 102F having the same shape as those of the oblong holes 102C, 102D through the other end portion of the second holding member 102 in the direction (the Y-axis direction in FIG. 12) in which the lamps are arranged, and to match these structures, the first insulation member 104, the second insulation member 105, and the chassis 106 of the illumination device for a display device have different shapes. The illumination device for a display device according to the fourth preferred embodiment of the present invention has a parallel electric circuit as an electric circuit. The structure having the two sets of the first and second holding members 101, 102 allows an easy application of the illumination device to a large display screen. As in a modification shown in FIG. 13, two power source devices 103 may be disposed to form two parallel electric circuits.

Besides, because a light reflection sheet made of an insulation material is usually disposed on the inner-side rear surface 106A (see FIG. 3) of the chassis of the illumination device for a display device, the first and second insulation members 104, 105 can be removed, and the light reflection sheet may be used to serve as the first and second insulation members 104, 105 concurrently. In addition, another structure may be employed, in which an insulation coating is applied to the inner-side rear surface 106A (see FIG. 3) of the chassis of the illumination device for a display device, the first and second insulation members 104,105 are removed, and the insulation coating is used instead of the first and second insulation members 104, 105.

If the chassis 106 of the illumination device for a display device is made of aluminum or stainless steel, it is necessary to prevent the chassis 106 of the illumination device for a display device from coming into contact with both the first and second holding members 101, 102. However, if the chassis 106 of the illumination device for a display device is made of an insulation material such as a resin, because it is not a problem even if the chassis 106 of the illumination device for a display device comes into contact with both the first and second holding members 101 and 102, the first and second insulating members 104, 105 can be removed. And, at the oblong hole 101E, the first holding member 101 is mounted on the chassis 106 of the illumination device for a display device by an insulation-material screw with degree of freedom in the main-axis direction (the X-axis direction in FIG. 12) of the lamp and with no degree of freedom in the direction (the Y-axis direction in FIG. 12) in which the lamps are arranged. Further, at the oblong hole 101F, the first holding member 101 is mounted on the chassis 106 of the illumination device for a display device by an insulation-material screw with a degree of freedom in both the main-axis direction (the X-axis direction in FIG. 12) of the lamp and the direction (the Y-axis direction in FIG. 12) in which the lamps are arranged. Moreover, at the oblong hole 102E, the second holding member 102 is mounted on the chassis 106 of the illumination device for a display device by an insulation-material screw with degree of freedom in the main-axis direction (the X-axis direction in FIG. 12) of the lamp and with no degree of freedom in the direction (the Y-axis direction in FIG. 12) in which the lamps are arranged. Further, at the oblong hole 102F, the second holding member 102 is mounted on the chassis 106 of the illumination device for a display device by an insulation-material screw with degree of freedom in both the main-axis direction (the X-axis direction in FIG. 12) of the lamp and the direction (the Y-axis direction in FIG. 12) in which the lamps are arranged.

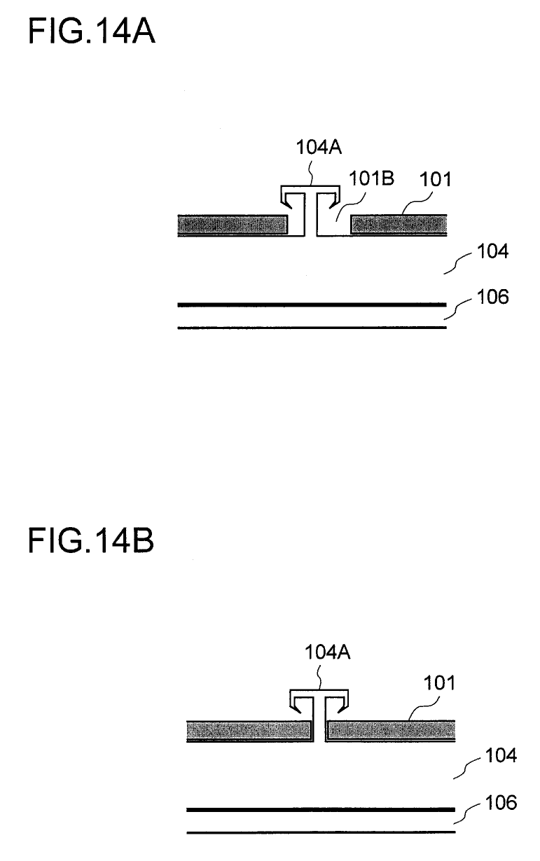

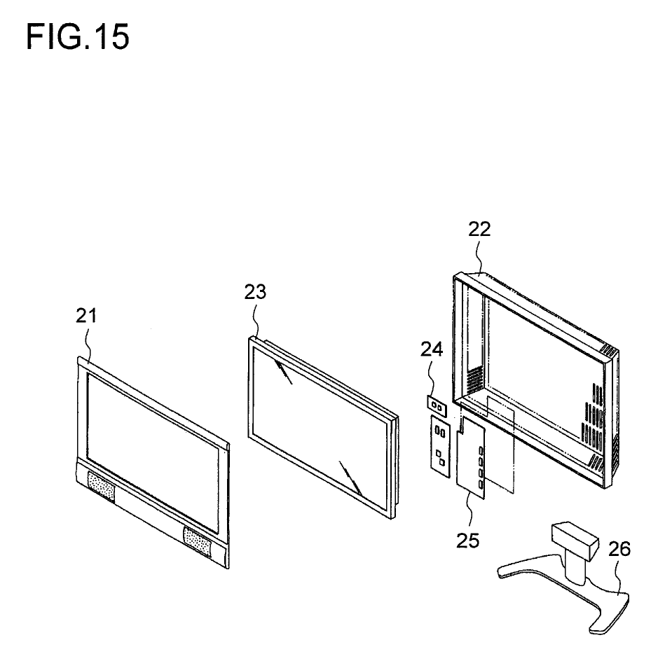

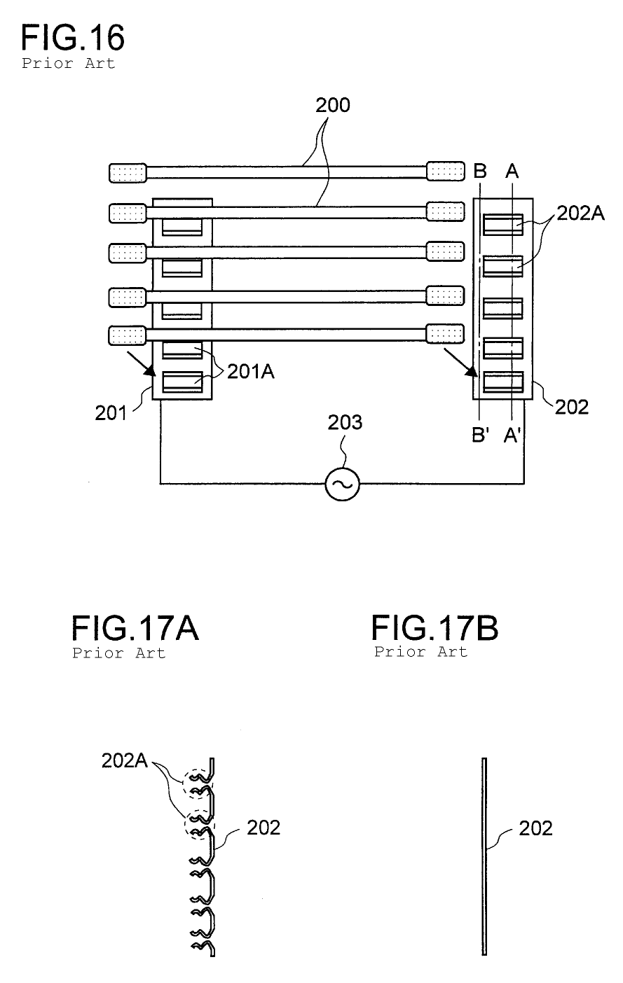

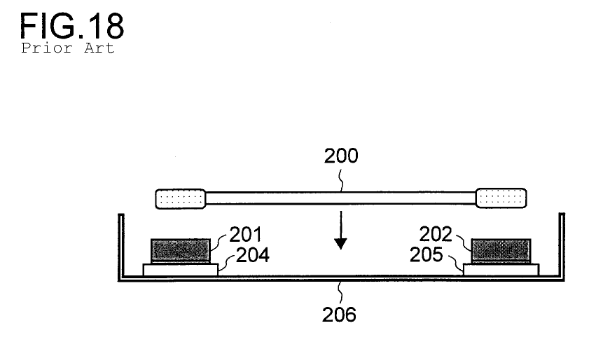

In the second to fourth preferred embodiments explained above, the holding members are mounted on the chassis of the illumination device for a display device with oblong holes and screws. However, the present invention is not limited to this. For example, the holding members may be mounted on the chassis of the illumination device for a display device with an engagement structure. An example of an engagement structure is shown in FIGS. 14A, 14B. FIGS. 14A, 14B are partially enlarged views of the oblong hole 101B of the first holding member 101. FIG. 14A is a sectional view in the X-axis direction in FIG. 8A, with no illustration of the holder 101A. FIG. 14B is a sectional view in the Y-axis direction in FIG. 8A. The first insulation member 104 includes an engagement portion 104A unitarily formed therewith, and the engagement portion 104A is inserted though the oblong hole 101B of the first holding member 101.

A display device according to various preferred embodiments of the present invention includes the illumination device for a display device explained above according to the present invention, and a display panel. As a specific display device according to various preferred embodiments of the present invention, for example, it is possible to provide a transmissive liquid crystal display device that includes the illumination device for a display device according to a preferred embodiment of the present invention used as a backlight unit, and a display panel disposed in front of the backlight unit.

An example of an exploded perspective view a liquid crystal television receiver as the display device according to a preferred embodiment of the present invention is shown in FIG. 15. A transmissive liquid crystal display portion 23, a tuner 24, and a power source 25 are disposed between a front frame 21 and a rear frame 22, and the rear frame 22 is held by a stand 26. The transmissive liquid crystal display portion 23 includes the illumination device for a display device according to the present invention used as a backlight unit, and a display panel disposed in front of the backlight unit.

In this preferred embodiment, the cold-cathode tube lamp shown in FIG. 1 is preferably used. However, the lamp used in the illumination device for a display device according to the present invention is not limited to this cold-cathode tube lamp, that is, a lamp that can be driven in parallel may be used. Besides, the other cold-cathode tube lamps disclosed in the International Publication WO2006/051698A1 and an external electrode fluorescent lamp may be used. For example, a lamp having a structure that is obtained by removing the insulation layers 8, 9 and the opposite electrodes 10, 11 from the cold-cathode tube lamp shown in FIG. 1 may be used. In this case, at least an insulation coating may be applied to the surfaces, which come into contact with the lamp, of the holder 101A of the first holding member 101 and of the holder 102A of the second holding member 102.

The holding member according to preferred embodiments the present invention can be used as a holding member that holds removably one end of each of a plurality of lamps which can be driven in parallel.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11: A holding member, comprising:
a plurality of holders each of which holds one end of a tube lamp drivable in parallel; wherein
the holding member supplies electric power output from a power source device to the tube lamp; and
the holding member includes a buffer portion arranged to buffer deformation stress acting in the direction in which the tube lamp is arranged.

12: The holding member according to claim 11, further comprising:
a plurality of fixed points that are fixed to another member; wherein
the buffer portion is arranged between two of the fixed points.

13: The holding member according to claim 11, wherein
the buffer portion has a shape that includes at least three bent portions; and
a connecting portion arranged to connect the bent portions with each other.

14: An illumination device for a display device, comprising:
a plurality of tube lamps drivable in parallel;
a first holding member including a plurality of holders each of which holds one end of each of the tube lamps and the number of which is the same as that of the tube lamps;
a second holding member including a plurality of holders each of which holds the other end of each of the tube lamps and the number of which is the same as that of the tube lamps;
a power source device arranged to supply electric power to the tube lamps via both the first holding member and the second holding member; and
a chassis; wherein
the first holding member and the second holding member are the holding member of claim 11.

15: The illumination device for a display device according to claim 14, wherein
the chassis includes an electroconductive material; and
an insulator is disposed between the first holding member and the chassis and between the second holding member and the chassis.

16: The illumination device for a display device according to claim 14, wherein the first holding member and the second holding member are mounted on the chassis with a degree of freedom in a main-axis direction of the lamps.

17: The illumination device for a display device according to claim 16, wherein
each of the first holding member and the second holding member includes a plurality of fixed points which, with respect to the chassis, have a degree of freedom in the main-axis direction of the tube lamps and have no degree of freedom in a direction in which the tube lamps are arranged; and
no fixed points which, with respect to the chassis, have a degree of freedom in both the main-axis direction of the tube lamps and the direction in which the tube lamps are arranged.

18: The illumination device for a display device according to claim 14, further comprising a plurality of sets of the first holding member, the second holding member, and the tube lamp which are held by the holder of the first holding member and by the holder of the second holding member.

19: A display device comprising an illumination device for a display device according to claim 14.

20: The display device according to claim 19, wherein the display device is a television receiver.
